(19) United States
(12) Patent Application Publication
(10) Pub. No.: US 2011/0183117 A1
(43) Pub. Date: Jul. 28, 2011

(54) HOME OR PERSONAL CARE PRODUCT

(76) Inventors: Harry Javier Barraza, Wirral (GB); Haruo Honjo, Fukuoka (JP); Hiroaki Katsuragi, Fukuoka (JP); Taketo Mizoue, Nagasaki-ken (JP); Masayuki Tokita, Fukuoka (JP)

(21) Appl. No.: 13/061,747

(22) PCT Filed: Aug. 20, 2009
(86) PCT No.: PCT/EP09/60767

§ 371 Date: Mar. 28, 2011

(30) Foreign Application Priority Data
Sep. 3, 2008 (EP) 08163597.1

(51) Int. Cl. B32B 3/10

(52) U.S. Cl. 428/156

(57) ABSTRACT

A home or personal care product comprising a gel, characterised in that the gel is formed from dimethyl acrylamide monomer crosslinked with a crosslinker and polymerised under conditions that cause the polymer to form a pattern due to corrugation or deformation in gel thickness of the order of 0.3 mm, preferably 0.5 mm or greater (macroscopic deformation visible to the naked eye).

### TECHNICAL FIELD

This invention relates to home or personal care products based on a gel polymer.

### BACKGROUND

Visual product appeal is a particularly important aspect in product sectors such as home and personal care.

Bubbles, beads and particulate materials, such as microcapsules, have been used to provide visual product appeal, as well as functional benefits, in personal care cleansing products such as shampoo and shower gel.

Pattern formation of soft materials occurs in nature. Many dissipative structures appear in soft materials and natural patterns have very wide range of diversity. The pattern formation of a polymer gel during volume phase transition (water uptake) is a typical example of such soft pattern formation. The appearance of patterns on the originally smooth surface of a polymer gel undergoing a volume phase transition (either continuous or discontinuous) was disclosed by Tanaka et al. Nature, 325, pp 796-798, 1987. Mechanical instability due to swelling or shrinking was shown to play a key role in the formation and evolution of such patterns. The gel used was a copolymer of acrylamide and sodium acrylate (to form an ionised gel). The osmotic pressure of counterions from the sodium acrylate exerts and internal osmotic pressure and causes the gel to expand when placed in water. The surface patterns that form during the water uptake are not permanent.

More recent work by Katsuragi H (2006) Europhys Lett 73:793 have shown a novel kind of pattern formation which appears during polymer gelation. Acrylamide (AA) gelation on a Petri-dish was shown to give a spontaneous surface deformation. The competition between the positive feedback of radical polymerization and the inhibition by oxygen is thought to be the main reason of this pattern formation. This surface deformation is actually a 3-dimensional (3D) phenomenon, while the gelation occurs in quasi 2D space. The situation is complex. The observed pattern looks like wrinkles on brains, or surface pattern on reptiles. Katsuragi postulates that reaction diffusion dynamics explains this pattern formation. However, there remain some difficulties to explain all aspects of the pattern formation using conventional reaction diffusion dynamics.

Self-organizing pattern formation is a frontier in material science. Most self-organized patterns show nano- or micro-meter order structures. To be of utility as visually compelling home and personal care products it is desired to form the patterns into a macro (millimeter order) structure. It is also necessary that the process to form these visible structures is easy to control. Such macro structures in soft matter will then have many applications in home and personal care products.

### SUMMARY OF THE INVENTION

According to the present invention there is provided a home or personal care product comprising a gel, characterised in that the gel is formed from dimethyl acrylamide monomer crosslinked with a crosslinker and polymerised under conditions that cause the polymer to form a pattern due to corrugation or deformation in gel thickness of 0.3 mm, preferably 0.5 mm or greater (macroscopic deformation visible to the naked eye).

### DETAILED DESCRIPTION OF THE INVENTION

### Definitions

“Home and Personal care (HPC) products” means all products, goods and services relating to the treatment, cleaning, caring or conditioning of either or both of the following (i) the person, (ii) the home and its contents. The foregoing shall include, but not be limited to, chemicals, compositions, products, or combinations thereof having a use or application in treatment, cleaning, cleansing, caring or conditioning of the person (including in particular the skin, hair and oral cavity) and/or household care and laundry care products for the treatment, cleaning, caring or conditioning of surfaces, furniture and atmosphere of the home and household contents, including laundry, and the manufacture of all of the foregoing. This definition shall also include, but not be limited to, any packaging, tools or devices for use with the same.

“Household Care product” means all products, goods and services relating to the treatment, cleaning, caring or conditioning of the home and its contents. The foregoing shall include, but not be limited to, chemicals, compositions, products, or combinations thereof having a use or application in treatment, cleaning, caring or conditioning of surfaces, furniture and atmosphere of the home and household contents, and the manufacture of all of the foregoing. This definition shall also include, but not be limited to, any packaging, tools or devices for use with the same.

“Laundry Care product” means all products, goods and services relating to the treatment, cleaning, caring or conditioning of clothes, fabrics and clothes fibres. The foregoing shall include, but not be limited to, chemicals, compositions, products, or combinations thereof having a use or application in treatment, cleaning, caring or conditioning of clothes, fabrics and clothes, fibres and also uses or applications of the foregoing in relation to irritation control, reduction of product linked skin reactions, skin moisturisation and barrier improvements, skin sensory reactions (itch, sting, burn), reduction of skin visible reactions e.g. redness and wheal and flare, and/or reduction of allergic responses (to laundry products and ingredients). This definition shall also include, but not be limited to, any packaging, tools or devices for use with the same.

“Personal Care product” means all products, goods and services relating to the treatment, cleaning, cleansing, caring or conditioning of the person. The foregoing shall include, but not be limited to, chemicals, compositions, products, or combinations thereof having a use or application in treatment, cleaning, cleansing, caring or conditioning of the person (including in particular the skin, hair and oral cavity) and the manufacture of all of the foregoing. This definition shall also include, but not be limited to, any packaging, tools or devices for use with the same.

“Skin product” means products that are intended to be marketed and sold for use in skin care. The benefits of Skin Care Products may include: skin color control or pigmentation (lightening or darkening), skin ageing treatment, skin ageing prevention, cellulite reduction, sensitive skin reaction reduction (itch, sting, burn), skin greasiness and sebum control, acne reduction, skin moisturisation, skin barrier improvement, reduction of skin dryness (flakiness), and/or skin shine improvement.

“Hair product” means all products, goods and services relating to the treatment, cleaning, perfuming, colouring, styling, caring or conditioning of hair, hair fibres and/or scalp. The foregoing shall include, but not be limited to, chemicals, compositions, products, or combinations thereof having a use or application to treat, clean, perfume, colour, style, care or condition any of the hair, hair fibres and/or scalp, and the manufacture of all of the foregoing in or as hair care or other personal care products. This definition shall also include, but not be limited to, any packaging, delivery means, tools or devices that may have use with the same.

“Oral product” means products intended to provide benefits in the field of oral care (oral cavity) which field shall include but not be limited to oral hygiene, teeth and gum care, reduction of gum diseases such as gingivitis and periodontitis, dental caries and oral sloughing, reduction or masking of bad breath, and/or dental cleaning, whitening, pigmentation and coloring and all products or services that are intended to be marketed and sold for use as or in the foregoing.

“Deodorant and Antiperspirant Product” means products that are intended to be marketed and sold for use to prevent or modify body odor or perspiration. Deodorant and Antiperspirants may have one or more of the following benefits: perspiration control (wetness control), prolonged wetness control, malodour and its control, hair removal and hair control, hair growth inhibition, irritation reduction and control, pigmentation reduction and control (includes post-inflammatory hyperpigmentation), and/or underarm flakiness and moisturisation.

The Gel

The gel polymer is cross linked DMAA (dimethyl acrylamide). The DMAA monomer may be used to form a homopolymer or it may be copolymerised with another monomer. Preferably an initiator and an accelerator are also used in the polymerisation. The crosslinker, any co monomer and the other major components of the gel apart from DMAA should be chosen bearing in mind low toxicity, low skin sensitisation and other desirable properties of any material that will be used in contact with the human skin, or will come into contact with the skin as an inevitable side effect of their use (e.g. by use in laundry washing products).

The initiator is preferably ammonium persulphate (APS). It is preferably used in an amount of from 0.3 to 2.5 parts based on 100 parts monomer, more preferably it is used in the range 0.4 to 1.5 most preferably 0.5 to 0.8 parts.

The crosslinker is preferably methylenebisacrylamide (BIS). It is preferably used in the range 0.1 to 0.3 parts based on 100 part monomer, most preferably 0.15 to 0.25 parts.

The accelerator is preferably tetramethylethylenediamine (TEMD). It is preferably used in the range 3 to 7 parts based on 100 parts monomer, more preferably 4 to 6 parts.

The macroscopic hydrated gel structure may be made by a process wherein the gel comprises surfactant and the amount of initiator is adjusted to control the macroscopic structure formation. In this case the weight ratio of surfactant to initiator is preferably in the range 4:1 to 20:1 for anionic surfactant and 2:1 to 10:1 for cationic surfactant. The polymerisation reaction may take place over a preferred temperature range of 10 to 60° C., more preferably 20 to 40° C. The reaction time may be from 1 to 24 hours, preferably from 2 to 6 hours. The oxygen concentration may lie in the range 5 to 40%; preferably it lies in the range 9 to 27%.

The gel product can be used as is, either free or fixed to a solid surface, especially one on which it has been polymerised. This could be the inside of a package; especially if the package is transparent.

The invention will now be further described, by way of example only, and with reference to the drawings, of which:

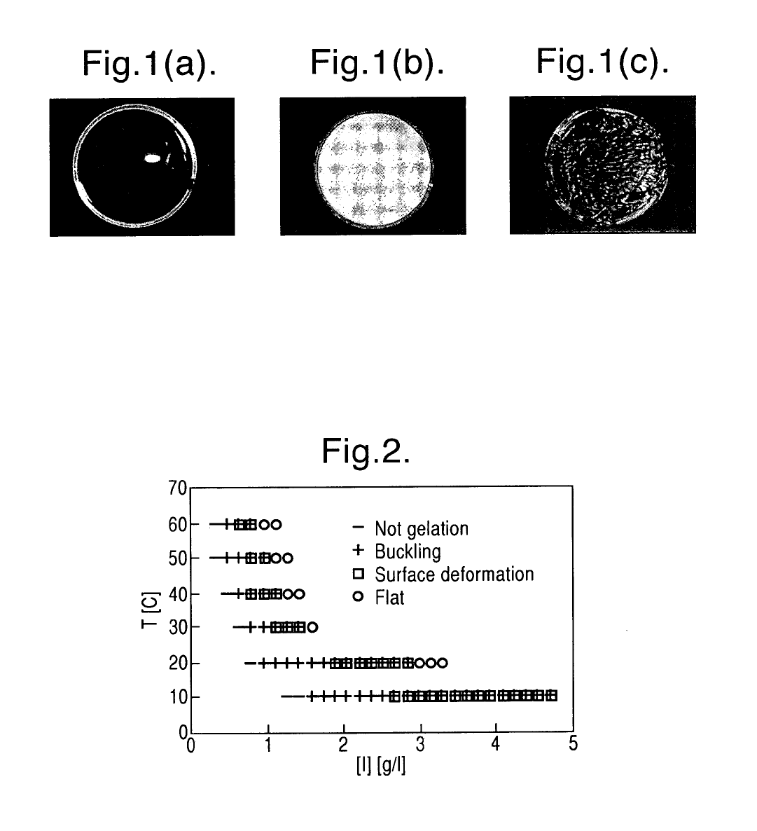

FIG. 1a is a depiction of gel patterns with SA monomer (=2 mg),

FIG. 1b is a depiction of gel patterns with NIPA monomer (=1.9 mg),

FIG. 1c is a depiction of gel patterns with DMAA monomer (=2.4 mg),

FIG. 2 is a phase diagram of DMAA gel slabs where [I]=initiator concentration.

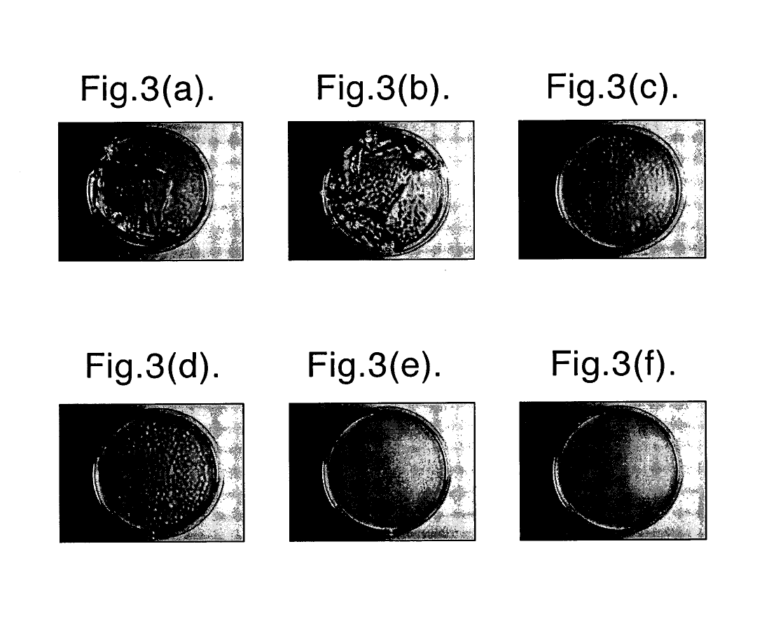

FIG. 3 is a photograph of examples of DMAA surface deformation and buckling.

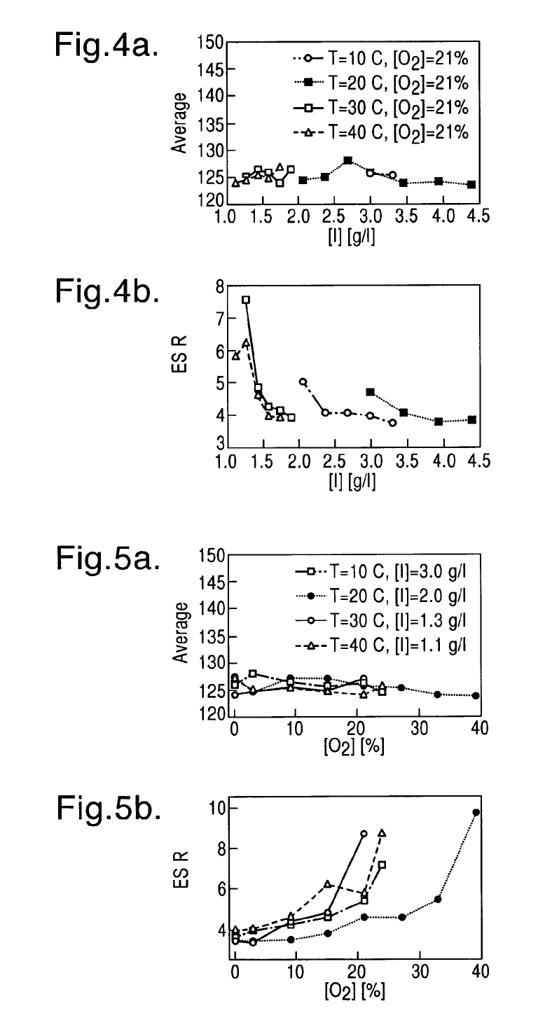

FIG. 4a Average Surface Roughness of varying initiator concentration [I] and temperature T.

FIG. 4b Effective Surface Roughness (ESR) of varying initiator concentration [I] and temperature T.

FIG. 5a Average Surface Roughness of varying oxygen concentration and temperature. Where [O₂] is the oxygen concentration.

FIG. 5b ESR of varying oxygen concentration and temperature. Where [O₂] is the oxygen concentration.

### EXAMPLES

We have further investigated the quasi 2D pattern formation with radical polymerization as described by Katsuragi. First, we investigated other less toxic monomers to see if one could be identified to replace the acrylamide used in the prior art. We also investigated the effect of polymerization initiator concentration and temperature. In addition, oxygen diffusion, which is known as an inhibitor for radical polymerization, was found to have a significant control over pattern formation dynamics. These three parameters were varied systematically and correlated to measurements of effective surface roughness of the resultant macroscopic pattern.

The macroscopic patterns obtained are reminiscent of other dissipative structures (e.g., Turing patterns), and were found to be a strong function of polymerization initiator concentration and temperature. In addition, oxygen diffusion, which is known as an inhibitor for radical polymerization, had significant control over pattern formation dynamics. These three parameters were varied systematically and correlated to measurements of effective surface roughness of resultant pattern.

### Examples 1 to 3 and Comparative Example A

Pre-gel solution is poured onto a Petri-dish, and it is left about 2 hours. Then, spontaneous surface deformation occurs depending on the experimental condition. In the prior art AA gel is used as a monomer. We tested three further monomers:

Sodium acrylate (SA, MW=94.05), N-Isopropylacrylamide (NIPA, MW=113.16), and Dimethylacrylamide (DMAA, MW=99.13). We used the prior art acrylamide gel formation as a comparative reference.

In all examples, Methylenbisacrylamide (BIS) is used as the cross linker and, Ammonium persulfate (APS) are used as initiator of, and Tetramethylethlyenediamine (TEMD) accelerator of, the radical polymerization. In all cases, 6 mg BIS, 70 μl TEMD, and 10 mg APS are dissolved to 12 ml deionized water under the room temperature.

Sample preparation and temperature control method are thus essentially the same as used in the prior art for acrylamide gel formation. However, we now additionally control the ambient oxygen concentration using an airtight chamber and O2, N2 gas cylinders to control gas fraction. After 2 hours polymerization, resulting surface patterns are taken by a CCD camera, and the photos are processed by a PC.

In FIGS. 1a, 1b, and 1c, typical patterns observed with each monomer are shown. It is hard to see a surface deformation with SA gel and NIPA gel. The DMAA gel shows a relatively clear surface pattern more or less similar to the reference AA gel. Thus, it appears that DMAA is a suitable alternative material to AA.

### Further examples Using DMAA

We systematically made DMAA gel slabs under various experimental conditions and composed the phase diagram as shown in FIG. 2. The specific experimental conditions are shown in Table 1.

TABLE 1
Experimental conditions

| | |
|---|---|
| DMAA [ml] | 1.8 |
| BIS [mg] | 4 |
| TEMD [μl] | 70 |
| water [ml] | 11 |
| APS [mg] | 0-60 |
| Temperature [° C.] | 10-60 |

The surface deformation pattern appears between the completely flat gelation (“Flat”) and the incomplete gelation (“Not-gelation”). This means that the inhibition of polymerization is a crucial process to make surface instability. In addition, the large scale buckling can be observed in the marginal region between the “Surface deformation” and “Not-gelation”. In the surface deformation pattern, the bottom plane of the gel slab is flat (i.e., the deformation is limited on the top surface), while the buckling includes bottom deformation. A noticeable feature of FIG. 2 phase diagram is wide patterning region in the relatively low temperature regime. This appears to be a characteristic feature of DMAA pattern formation and is different from the prior art AA.

Effective Surface Roughness Analysis

In order to quantify the degree of surface deformation, we employed the standard deviation of 2D photos. We can recognize the surface deformation through the contrast of 2D photos (like FIG. 3). This suggests that the standard deviation of 2D photos can be used as an indicator of the surface deformation degree. In FIG. 3, typical 2D pictures with varying initiator concentration are presented. 1.8 ml DMAA, 4 mg BIS, 70 μl TEMD, and 11 ml deionised water are used.

Environmental temperature is controlled as 30 degree Celsius. The amount of initiator (APS) is varied as 3(a) 10, 3(b) 12, 3(c) 14, 3(d) 16, 3(e) 18, 3(f) 20 mg, respectively.

As can be seen in FIG. 3, increasing initiator concentration tends to suppress the surface deformation. Moreover, buckling can be observed in very low initiator levels. We seek to avoid such a buckling regime when using the technology to make home and personal care products. To characterize these photos, central part (1,000 pix.×1,000 pix.) of raw data (3,072 pix.×2,304 pix.) is extracted from each photo. Then, the data are translated to 8 bit gray scale, and finally the standard deviation and average of the photo intensity values are computed. We define this standard deviation as the effective surface roughness (ESR).

First, we vary the initiator concentration and temperature under atmospheric condition (ambient oxygen concentration is about 21%). Since the surface deformation regime is limited as shown in FIG. 2 phase diagram, the completely independent change of initiator concentration and temperature is difficult. We have to adjust both of them simultaneously to create surface deformation pattern. We show the computed average and ESR values in FIG. 4. While almost the constant average intensity is confirmed in FIG. 4(a), increasing ESR is observed for decreasing initiator concentration. This trend is consistent with pictures in FIG. 3. The almost constant average indicates the reproducible lighting and/or other external noise factors. The negative correlation between the ESR and initiator concentration implies that the more the initiator, the more stable the polymerization. As a result, a uniform flat slab is created in the case with sufficient amount of initiator polymerization.

Next, the ambient oxygen and temperature are maintained to create surface deformed slabs. We have to vary the initiator concentration as well to create clear surface deformation, owing to the narrow patterning regime (same reason as previous FIG. 4 case). The measured average intensity and ESR are shown in FIG. 5. Constant average intensity is the same trend as FIG. 4 case. However, the ESR and oxygen concentration shows positive correlation. This trend is consistent with the inhibition effect of oxygen in radical polymerization. The oxygen scavenges and stops the radical polymerization, so that the flat surface is inhomogeneous and unstable. This is presumably the principal origin of surface instability.

This oxygen inhibitor effect corresponds to the counter against the initiator stabilizing effect.

1. A home or personal care product comprising a gel, characterised in that the gel is formed from dimethyl acrylamide monomer crosslinked with a crosslinker and polymerised under conditions that cause the polymer to form a pattern due to corrugation or deformation in gel thickness of the order of 0.3 mm, preferably 0.5 mm or greater (macroscopic deformation visible to the naked eye).

2. A product according to claim 1 wherein the crosslinker is methylenebisacrylamide.

3. A product according to claim 1 wherein an initiator and an accelerator are also present during the polymerisation.

4. A product according to claim 3 wherein the initiator is ammonium persulphate.

5. A product according to claim 3 wherein the accelerator is tetramethylethylenediamine.

6. A product according to claim 3 wherein the gel further comprises surfactant and the amount of initiator is adjusted to control the macroscopic structure formation.

7. A product according to claim 6 wherein the weight ratio of surfactant to initiator is in the range 4:1 to 20:1 for anionic surfactant and 2:1 to 10:1 for cationic surfactant.

8. Use of the gel product according to claim 1 fixed to a solid surface, preferably a surface on which it has been polymerised.

9. Use according to claim 8 wherein the surface is the inside of a package.

10. Use according to claim 9 wherein the package is transparent.
